(19) United States
(12) Patent Application Publication
(10) Pub. No.: US 2026/0239235 A1
(43) Pub. Date: Aug. 13, 2026

(54) METHODS AND APPARATUS OF DYNAMIC PDSCH POWER ALLOCATION AND CSI FEEDBACK

(71) Applicant: Lenovo (Beijing) Limited, Beijing (CN)

(72) Inventors: Zhi Yan, Beijing (CN); Yuantao Zhang, Beijing (CN); Ruixiang Ma, Beijing (CN); Yingying Li, Beijing (CN); Haiming Wang, Beijing (CN)

(73) Assignee: Lenovo (Beijing) Limited, Beijing (CN)

(21) Appl. No.: 19/156,690

(22) PCT Filed: Feb. 17, 2023
(86) PCT No.: PCT/CN2023/076764

§ 371 Date: Aug. 14, 2025

(51) Int. Cl. H04W 52/36; H04B 7/06; H04W 52/40

(52) U.S. Cl. CPC H04W 52/367; H04B 7/0626; H04W 52/40

(57) ABSTRACT

Methods and apparatus of dynamic PDSCH power allocation and CSI feedback are disclosed. The apparatus includes a receiver that receives a data signal and a reference signal; wherein a power offset between the data signal and the reference signal is determined by at least one of a first power offset p0 and a second power offset p1; and a transmitter that transmits a feedback report associated with the reference signal.

### FIELD

The subject matter disclosed herein relates generally to wireless communication and more particularly relates to, but not limited to, methods and apparatus of dynamic PDSCH power allocation and CSI feedback.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX, or Rx), Transmit or Transmitter (TX, or Tx), Physical Downlink Shared Channel (PDSCH), Physical Broadcast Channel (PBCH), Bandwidth Part (BWP), Control Element (CE), Channel State Information (CSI), Channel State Information Reference Signal (CSI-RS), Downlink Control Information (DCI), Frequency Division Multiple Access (FDMA), Index/Identifier (ID), Media Access Control (MAC), Media Access Control-Control Element (MAC CE), Radio Resource Control (RRC), Reference Signal (RS), Reference Signal Received Power (RSRP), Signal-to-Interference-Plus-Noise Ratio (SINR), Sounding Reference Signal (SRS), Synchronization Signal Block (SSB), Secondary Synchronization Signal (SSS), Transmission Reception Point (TRP), Channel Quality Indicator (CQI), Frequency Range 1 (FR1), Frequency Range 2 (FR2), Layer 1 Reference Signal Received Power (L1-RSRP), Precoder Matrix Indicator (PMI), Rank Indicator (RI), Technical Specification (TS), Energy per resource element (EPRE), Layer 1/physical layer (L1), Universal Terrestrial Radio Access Network (UTRAN), CSI-RS Resource Indicator (CRI), Layer Indicator (LI), SS/PBCH Block Resource Indicator (SSBRI), Non-Zero Power CSI-RS (NZP CSI-RS), Layer 1 Signal to Interference plus Noise Ratio (L1-SINR), Synchronization Signals and Physical Broadcast Channel (SS/PBCH).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHZ) is called FR2. The 5G NR supports both FR1 and FR2 frequency bands.

Enhancements in dynamic PDSCH power allocation and the corresponding CSI feedback are subjects of study in the present disclosure, which would be useful in network energy saving for 5G communication.

### SUMMARY

Methods and apparatus of dynamic PDSCH power allocation and CSI feedback are disclosed.

According to a first aspect, there is provided an apparatus, including: a receiver that receives a data signal and a reference signal; wherein a power offset between the data signal and the reference signal is determined by at least one of a first power offset p0 and a second power offset p1; and a transmitter that transmits a feedback report associated with the reference signal.

According to a second aspect, there is provided an apparatus, including: a transmitter that transmits a data signal and a reference signal; wherein a power offset between the data signal and the reference signal is determined by at least one of a first power offset p0 and a second power offset p1; and a receiver that receives a feedback report associated with the reference signal.

According to a third aspect, there is provided a method, including: receiving, by a receiver, a data signal and a reference signal; wherein a power offset between the data signal and the reference signal is determined by at least one of a first power offset p0 and a second power offset p1; and transmitting, by a transmitter, a feedback report associated with the reference signal.

According to a fourth aspect, there is provided a method, including: transmitting, by a transmitter, a data signal and a reference signal; wherein a power offset between the data signal and the reference signal is determined by at least one of a first power offset p0 and a second power offset p1; and receiving, by a receiver, a feedback report associated with the reference signal.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating an example of conventional power allocation for CSI-RS and PDSCH in accordance with some implementations of the present disclosure;

FIG. 5 is a flow chart illustrating steps of dynamic PDSCH power allocation by UE in accordance with some implementations of the present disclosure; and

FIG. 6 is a flow chart illustrating steps of dynamic PDSCH power allocation by gNB in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

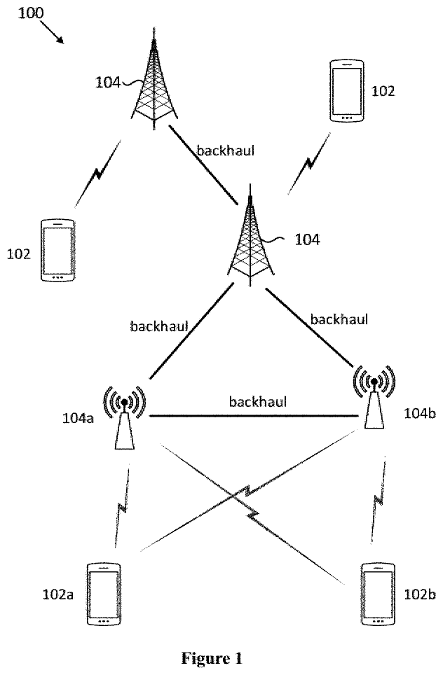

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP”, “Transmission Reception Point”, and “transmitting-receiving identity” may be used interchangeably throughout the disclosure.

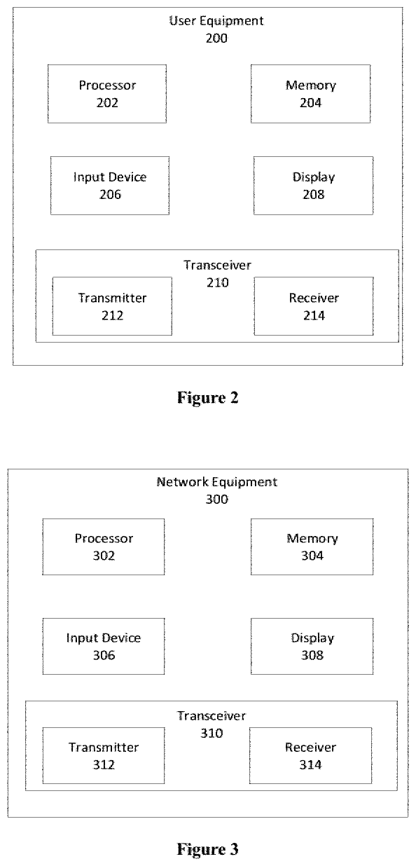

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

It is agreed in 3GPP that enhancements on CSI related procedures including measurement and report, and signalling to enable efficient adaptation of power offset values between PDSCH and CSI-RS should be specified for network energy saving.

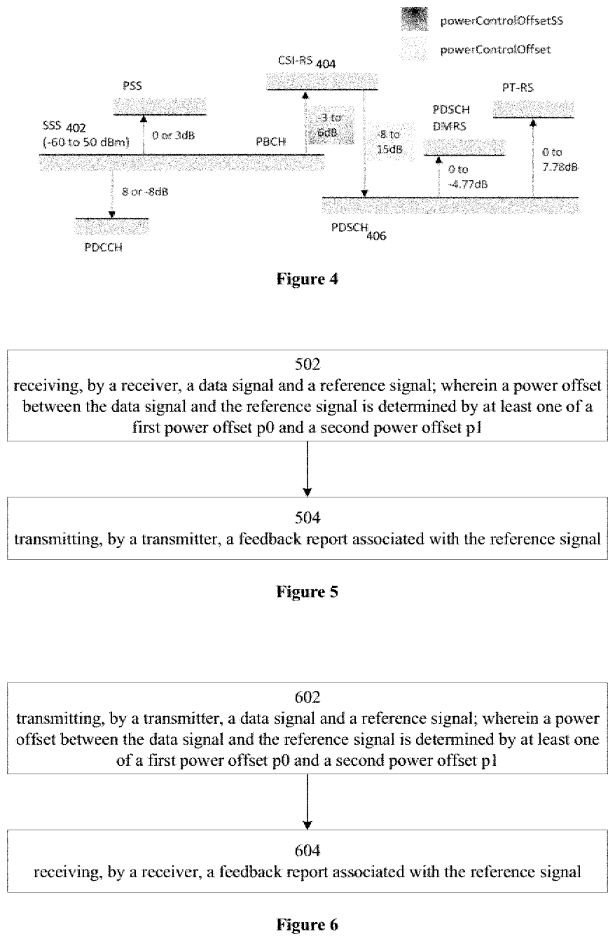

FIG. 4 is a schematic diagram illustrating an example of conventional power allocation for CSI-RS and PDSCH in accordance with some implementations of the present disclosure.

As per current specification, the downlink SS/PBCH SSS EPRE 402 may be derived from the SS/PBCH downlink transmit power given by the parameter ss-PBCH-BlockPower provided by higher layers, which may be an integer value in the range of (−60 . . . 50) dBm.

The downlink CSI-RS EPRE 404 may be derived from the SS/PBCH block downlink transmit power given by the parameter ss-PBCH-BlockPower and CSI-RS power offset given by the parameter powerControlOffsetSS provided by higher layers, which may be a value selected from {db-3, db0, db3, db6}. The parameter powerControlOffsetSS is the assumed ratio of NZP CSI-RS EPRE 404 to SS/PBCH block EPRE 402, and may be configured via RRC signalling.

The parameter powerControlOffset, which is the assumed ratio of PDSCH EPRE 406 to NZP CSI-RS EPRE 404 when UE derives CSI feedback and takes values in the range of [−8, 15] dB with 1 dB step size, is semi-statically configured via RRC signalling. The power offset configurations for PDSCH and CSI-RS are BWP-specific. The current specification allows gNB to adapt the PDSCH transmission power.

For network energy saving study, dynamic power adaptation on RS and/or PDSCH was considered. In Release 18 work scope, it is agreed that dynamic power adjustment may be enabled for only PDSCH; and the SSB power and the CSI-RS power may not be dynamically changed. Enhancements of CSI measurement and reporting need to be considered as the actual transmission power of PDSCH is dynamically changed compared to that of CSI-RS.

There are several components of CSI in NR: CQI (Channel Quality Information), PMI (Precoding Matrix Indicator), CRI (CSI-RS Resource Indicator), SSBRI (SS/PBCH Resource Block Indicator), LI (Layer Indicator), RI (Rank Indicator) and L1-RSRP.

In the present 3GPP technical specification TS 38.214, regarding to CQI reporting, for CQI calculation based on a pair of NZP CSI-RS resources, powerControlOffset of each NZP CSI-RS resource in the pair of NZP CSI-RS resources for channel measurement is the assumed ratio of EPRE when UE derives CSI feedback and takes values in the range of [−8, 15] dB with 1 dB step size. For L1-SINR Reporting, when NZP CSI-RS is configured for channel measurement and/or interference measurement, the reported L1-SINR values should not be compensated by the power offset(s) given by higher layer parameter powerControOffsetSS or powerControlOffset.

The present disclosure provides solutions of dynamic PDSCH power allocation indication and corresponding CSI feedback enhancements considering multiple hypothetical power allocation offsets.

In the present disclosure, regarding dynamic indication of power ratio of PDSCH EPRE to CSI-RS EPRE, solutions are proposed on how to configure or determine the power ratio range or potential power ratio value. DCI overhead is also taken into consideration.

In CSI feedback reporting, some CSI information (e.g., CQI) is calculated/derived at the UE side based on the power ratio of PDSCH EPRE to CSI-RS EPRE. The configured powercontrolOffset value is the ratio assumed by the UE for the UE derivation of the CSI feedback. And if the actual power offset between PDSCH EPRE and CSI-RS EPRE is quite different from the configured value of powercontrolOffset with the introduction of dynamic PDSCH transmission power indication, this will impact the CSI feedback estimation at the UE. Thus, the legacy configuration of the power offset value between PDSCH and NZP CSI-RS needs to enhance to assist network energy saving operation.

In multiple CSI results reporting for one CSI feedback assuming multiple hypothetical power offsets between PDSCH and CSI-RS, solutions are proposed on how to determine the multiple hypothetical power offsets. In the present disclosure, the terms “power offset” and “offset power” are equivalent and may be used interchangeably.

In CSI feedback reporting, in order to save the CSI feedback overhead and facilitate the gNB scheduling, the trade-off between the signalling overhead and performance loss is taken into consideration.

### PDSCH Power Dynamic Indication

To achieve dynamic indication of PDSCH power, a new parameter, i.e., a further power offset, may be introduced; and the ratio of PDSCH EPRE to NZP CSI-RS EPRE may be determined by a first power offset p0 configured by higher layer parameter powerControlOffset, e.g., an integer value in the range of [−8, 15] dB, and/or a second power offset p1 indicated by DCI or MAC CE.

The value of p1 may be the total offset power (i.e., if the first power offset p0 is not configured by higher layer parameter powerControlOffset, the total ratio of PDSCH EPRE to the CSI-RS EPRE is only indicated by value of p1); alternatively, it may be the additional offset power in addition to the offset power of p0 (i.e., the ratio of PDSCH EPRE to CSI-RS EPRE in addition to p0). For example, the value of p0 may be configured as −3 dB, and the additional offset power p1 indicated by DCI or MAC CE is −5 dB, so the total ratio of PDSCH EPRE to NZP CSI-RS EPRE may be −8 dB.

In some examples, the value of p1 may be selected from an offset power set P1, elements of which are determined by its cardinal number N and power step S configured by higher layer.

Since PDSCH power reduction is considered for network energy saving, the offset power set P1 includes power offsets with negative integers and/or 0. For example, P1={−3,−2,−1,0}. This restriction may be useful for DCI overhead reduction.

In some examples, in order to be compatible with the legacy power offset range (e.g., in order to facilitate the UE implementation), the total power ratio of PDSCH to CSI-RS should be larger than-8 dB. The cardinal number N or the power step S is determined by p0, e.g., N=ceil {(p0+8)/S}, or S-ceil {(p0+8)/N}. In this case, only one of the cardinal number N and the power step S may need to be configured by higher layer.

For example, the ratio of PDSCH EPRE to NZP CSI-RS EPRE is configured as p0=3 dB, and the cardinal number N of P1 is configured as 4, so the power step S=ceil {(3+8)/4}=3, and the offset power set P1={0,−3,−6,−9}, p1 indicates the additional power offset from the offset power set P1. In this case, the total potential power offset p0+p1={3, 0, −3, −6}.

Optionally, P1={0, −1, . . . , −(p0+8)} with all possible offset power values larger than −(p0+8) with step of 1 dB. Alternatively, in the case where p1 indicates the total power offset, P1 may be determined as P1={p0, p0−1, . . . , −8}. In this example, no configuration of the cardinal number N or the power step S would be required.

In some other examples, both the cardinal number N and the power step S are configured by higher layers, e.g., P1={0,−S, −2S, . . . , −(N−1) S}.

For example, the ratio of PDSCH EPRE to NZP CSI-RS EPRE is configured as p0=3 dB, and the cardinal number N and the power step S are configured as 4 and 2, respectively, so the offset power set P1={0, −2, −4, −6}, p1 indicates the additional power offset from the offset power set P1. In this case, the total potential power offset p0+p1={3, 1, −1, −3}.

### CSI Feedback Enhancement

In order to facilitate the PDSCH scheduling, multiple hypothetical power ratios of PDSCH EPRE to NZP CSI-RS EPRE are assumed when UE derives CSI feedback. The hypothetical power ratios of PDSCH EPRE to CSI-RS EPRE may also be referred to as the hypothetical power offsets between PDSCH and CSI-RS.

In the below examples relating to CSI feedback enhancements, the offset power p1 indicates the additional power offset for illustration purpose. In order to facilitate the PDSCH scheduling and avoid the CSI inaccuracy, at least the ratio of PDSCH EPRE to NZP CSI-RS EPRE determined by p0 configured by higher layer parameter powerControlOffset plus the offset power p1 is assumed when UE derives CSI feedback.

The offset power p1 is the latest p1 the UE received in DCI or MAC CE a gap period before the CSI feedback, and the gap period is used for UE processing.

For periodic CSI, Semi-Persistent CSI and Aperiodic CSI feedback, the CSI feedback reporting is associated with a CSI-RS resource, and the higher layer parameter powerControlOffset is configured in the CSI-RS resource. Besides the hypothetical power ratio of PDSCH EPRE to NZP CSI-RS EPRE of p0 is assumed when the UE derives the CSI feedback, additional hypothetical power ratios of PDSCH EPRE to NZP CSI-RS EPRE of p0+p1 are assumed when the UE derives the CSI feedback.

In some examples, for the CSI report, multiple CSI results for configured CSI-RS are reported in one CSI feedback, and the multiples CSI results or values are determined by the multiple hypothetical power ratios of PDSCH EPRE to NZP CSI-RS EPRE, and the multiple hypothetical power ratios of PDSCH EPRE to NZP CSI-RS EPRE is determined as follows.

In the following, ReportQuantity “cri-RI-PMI-CQI” is taken as an example of CSI feedback, as other quantities may not be impacted by the dynamic power ratios.

In one example, the parameters PMI/LI/RI/CQI (e.g., all CSI information) are reported with the assumption of multiple hypothetical power ratios of PDSCH EPRE to NZP CSI-RS EPRE.

In another example, in order to save the feedback overhead, limited CSI information (e.g., only CQI information) may be reported with the assumption of multiple power ratios of PDSCH EPRE to NZP CSI-RS EPRE, and other CSI information (e.g., CRI/RI/PMI) may be reported with the assumption that the ratio of PDSCH EPRE to NZP CSI-RS EPRE is p0 or p0+p1.

The multiple hypothetical power ratios of PDSCH EPRE to CSI-RS EPRE, or the multiple hypothetical power offsets between PDSCH and CSI-RS include at least one of the following:
the ratio determined by p0, which is configured by higher layer powerControlOffset;
the ratio determined by p0 plus the power offset p1;
the ratios determined by all power offsets in the offset power set P1;
the ratios determined by a subset of power offsets in the offset power set P1;
the ratios determined by p0, the power offset p1 and a further power offset p2;
the minimal or maximal power offset of any of the above power offsets; and
a constant power offset.

In some examples, the multiple hypothetical power offsets that are assumed include the ratios determined by all power offsets in the offset power set P1. One example with an offset power set P1 for the dynamic PDSCH power indication being {0, −S, −2S, . . . , −5S} is shown in Table 1, in which the hypothetical power ratio assumption includes all potential power ratios from p0 to p0-5S.

TABLE 1
Hypothetical power offsets including all power offsets in P1

| | | | | | | |
|---|---|---|---|---|---|---|
| PDSCH power ratio | p0-5S | p0-4S | p0-3S | p0-2S | p0-S | p0 |
| indication | | | | | | |
| hypothetical power | p0-5S | p0-4S | p0-3S | p0-2S | p0-S | p0 |
| ratio assumption | | | | | | |

In this example, all potential power ratios are assumed when the UE derives the CSI feedback, and feedback overhead is very large.

In some other examples, the multiple hypothetical power offsets that are assumed include only the ratios determined by a subset of power offsets in the offset power set P1.

The subset of power offsets may be extracted from the offset power set P1 with the same interval, power index, or multiple power step. For example, an interval of two may be assumed, as shown in Table 2 which illustrates an example with the same offset power set P1 as that of Table 1. The hypothetical power ratio assumption in the example includes power ratios of p0, p0-2S and p0-4S.

TABLE 2
Hypothetical power offsets including
a subset of power offsets in P1

| | | | | | | |
|---|---|---|---|---|---|---|
| PDSCH power ratio | p0-5S | p0-4S | p0-3S | p0-2S | p0-S | p0 |
| indication | | | | | | |
| hypothetical power | p0-5S | p0-4S | p0-3S | p0-2S | p0-S | p0 |
| ratio assumption | | | | | | |

In this example, a subset of potential power ratios is assumed, i.e., with only index of 0, 2, 4 or step of 2S. There is a possibility that the target power ratio (e.g., p0-3S may be the target power ratio in the example) is not assumed, but feedback overhead is controllable.

In some further examples, the power ratios may be determined by p0, the power offset p1 and a further power offset p2, where p2 is a positive integer configured by higher layer, e.g., power ratios={p0+p1−p2, p0+p1+p2}. That is, the multiple hypothetical power offsets include ratios determined by p0, the power offset p1 and the power offset p2. For example, p2 may be power offset step S, and thus, a subset of the potential power offsets in P1, which is {p0, p0+p1, p0+p1−S, p0+p1+S}, is assumed in CSI feedback reporting and the CSI feedback overhead is controllable. For example, p2 may be power offset step S (i.e., 1S), where the latest p1 the UE received in DCI or MAC CE a gap period before the CSI feedback is assumed to be −3S, as shown in Table 3. The hypothetical power ratio assumption in this example includes power ratios={p0, p0+p1+p2, p0+p1, p0+p1−p2}, i.e. {p0, p0−2S, p0−3S, p0−4S}.

In this example, a subset of potential power ratios is assumed, and thus feedback overhead is controllable.

In the cases where p0+p1−p2<−8 dB, the ratio of −8 dB is assumed, and in the cases where p0+p1+p2>15 dB, the ratio of 15 dB is assumed, in order to be compatible with the legacy power offset range of −8 dB to 15 dB. Thus, the hypothetical power offsets may be determined by ratios={max (−8, p0+p1−p2), min (15, p0+p1+p2)}.

TABLE 3
Hypothetical power offsets with a further power offsets p2 = S

| | | | | | | |
|---|---|---|---|---|---|---|
| PDSCH power ratio | p0-5S | p0-4S | p0-3S | p0-2S | p0-S | p0 |
| indication | | | | | | |
| hypothetical power | p0-5S | p0-4S | p0-3S | p0-2S | p0-S | p0 |
| ratio assumption | | | | | | |

In order to further reduce the CSI feedback overhead, limited CSI information (e.g., CQI) may be feedback with the assumption of multiple power ratios of PDSCH EPRE to NZP CSI-RS EPRE when the UE derives the CSI feedback.

Similar to design or mechanism of subband differential CQI reporting, a subband differential CQI offset level may be reported, which is the difference between a subband CQI index and the corresponding wideband CQI index.

Differential CQI range or potential values of differential CQI may be determined by the assumed power ratios of PDSCH EPRE to NZP CSI-RS EPRE since CQI is determined by the actual power of PDSCH (e.g., larger power ratio resulting in higher CQI). The differential CSI based on wideband or subband may be adopted for CQI in both wideband and subband.

The multiple CSI results or values may include at least one differential CSI value, representing an offset between a first CSI value determined by a first one of the hypothetical power offsets and a second CSI value determined by a reference hypothetical power offset. Reference to CSI value and differential CSI value may be reference to the corresponding CQI value and differential CQI value, respectively.

The reference hypothetical power offset may be one of:
the first power offset p0,
the first power offset p0 plus the second power offset p1,
a smallest power offset of all the hypothetical power offsets,
a smallest power offset of all the hypothetical power offsets that is larger than the first one of the hypothetical power offsets, and
a largest power offsets of all the hypothetical power offsets that is smaller than the first one of the hypothetical power offsets.

Multiple CSI values may be included in one CSI reporting, wherein one CSI value is reported with CSI (e.g., CQI) assuming power ratios of PDSCH EPRE to NZP CSI-RS EPRE of p0 or p0+p1, and other CSI values are reported with differential CSI (e.g., delta CQI) assuming power ratios of PDSCH EPRE to NZP CSI-RS EPRE other than p0 or p0+p1, compared with the CSI (e.g., CQI) assuming power ratios of PDSCH EPRE to NZP CSI-RS EPRE of p0 or p0+p1 (e.g., reference hypothetical power offset).

In some examples, for the CSI report, differential CSI (e.g., delta CQI) is reported compared with the CSI (e.g., CQI) assuming power ratios of PDSCH EPRE to NZP CSI-RS EPRE of p0 or p0+p1, as shown in Table 4 and Table 5, respectively.

TABLE 4
Delta CQI with assumption of p0 for CQI

| Power ratio assumption | Delta CQI |
|---|---|
| p0 | 0 |
| p0 + p1 | {−4, −3, −2, −1, 0} |

In the example shown in Table 4, the reference hypothetical power offset is p0. The differential CSI (e.g., delta CQI) is reported compared with the CSI (e.g., CQI) assuming power ratios of PDSCH EPRE to NZP CSI-RS EPRE of p0.

TABLE 5
Delta CQI with assumption of p0 + p1 for CQI

| Power ratio assumption | Delta CQI |
|---|---|
| p0 | {0, 1, 2} |
| p0 + p1 | 0 |
| p0 + p1 − p2 | {−2, −1, 0} |
| p0 + p1 + p2 | {0, 1, 2} |

In the example shown in Table 5, the reference hypothetical power offset is p0+p1. The differential CSI (e.g., delta CQI) is reported compared with the CSI (e.g., CQI) assuming power ratios of PDSCH EPRE to NZP CSI-RS EPRE of p0+p1.

In some examples, for assumption ratio of PDSCH EPRE to NZP CSI-RS EPRE of p0+p1+p2, differential CQI to CQI with assumption ratio of PDSCH EPRE to NZP CSI-RS EPRE of p0+p1 may be zero or positive value (0,1); for assumption ratio of PDSCH EPRE to NZP CSI-RS EPRE of p0+p1−p2, differential CQI to CQI with assumption ratio of PDSCH EPRE to NZP CSI-RS EPRE of p0+p1 may be zero or negative value (0, −1)

Optionally, the differential CSI may be reported as values compared with the CSI derived from smallest ratios of PDSCH EPRE to NZP CSI-RS EPRE assumption in all potential power ratio assumptions, as shown in Table 6.

TABLE 6
Delta CQI with assumption of smallest ratio for CQI

| Power ratio assumption | Delta CQI |
|---|---|
| p0 | {0, 1, 2, 3} |
| p0 + p1 | {0, 1, 2, 3} |
| p0 + p1 − p2 | 0 |
| p0 + p1 + p2 | {0, 1, 2, 3} |

In this example, the differential CSI (e.g., delta CQI) is reported compared with the CSI (e.g., CQI) assuming smallest power ratios of PDSCH EPRE to NZP CSI-RS EPRE of p0+p1−p2.

Optionally, the differential CSI may be reported as values compared with the CSI derived from smallest or highest ratios of PDSCH EPRE to NZP CSI-RS EPRE assumption that is larger or smaller than the ratio itself, as shown in Table 7. In this case, the differential CSI range is limited.

For example, it may be assumed that p0=3 dB, p1=−3 dB, and p2=1 dB. Based on the above disclosure, the hypothetical power ratio assumption of {p0, p0+p1, p0+p1−p2, p0+p1+p2} may be derived as {3, 0, −1, 1}. Thus, the highest power ratio of PDSCH EPRE to NZP CSI-RS EPRE assumption is 3 dB for p0 ranked 1st in Table 7. UE calculates CQI assuming the power ratio of PDSCH to CSI-RS of p0−3 dB; the corresponding CQI value is 9 assuming the power ratio of PDSCH to CSI-RS of p0=3 dB; and the delta CQI is zero (0).

The next highest ratio of PDSCH EPRE to NZP CSI-RS EPRE assumption is 1 dB for p0+p1+p2 ranked 2nd in Table 7. The reference hypothetical power offset is the smallest power offset of all the hypothetical power offsets (3 dB) that is larger than the present hypothetical power offsets (1 dB), namely it is in comparison with CQI assuming power offset of p0-3 dB. The corresponding CQI value is 8; and the delta CQI is one (1).

The third highest ratio of PDSCH EPRE to NZP CSI-RS EPRE assumption is 0 dB for p0+p1 ranked 3rd in Table 7. The reference hypothetical power offset is the smallest power offset of all the hypothetical power offsets (1 dB) that is larger than the present hypothetical power offsets (0 dB), namely it is in comparison with CQI assuming power offset of p0+p1+p2=1 dB. The corresponding CQI value is 8; and the delta CQI is zero (0).

The fourth highest ratio of PDSCH EPRE to NZP CSI-RS EPRE assumption is −1 dB for p0+p1−p2 ranked 4th in Table 7. The reference hypothetical power offset is the smallest power offset of all the hypothetical power offsets (0 dB) that is larger than the present hypothetical power offsets (−1 dB), namely it is in comparison with CQI assuming power offset of p0+p1−0 dB. The corresponding CQI value is 7; and the delta CQI is one (1).

Thus, with this reporting scheme, only one bit, i.e. {0, 1}, is required for reporting the delta CQI for each of the hypothetical power offsets.

TABLE 7
Delta CQI with comparison to next smallest ratio

| Power ratio | Power ratio assumption | |
|---|---|---|
| assumption | after ranking | Delta CQI |
| p0 | 1 | 0 |
| p0 + p1 | 3 | {0, 1} |
| p0 + p1 − p2 | 4 | {0, 1} |
| p0 + p1 + p2 | 2 | {0, 1} |

In this example, for each CSI (e.g., delta CQI), it is reported compared with the CSI (e.g., CQI) assuming smallest power ratios of PDSCH EPRE to NZP CSI-RS EPRE which is larger than the CSI assuming power ratios itself.

FIG. 5 is a flow chart illustrating steps of dynamic PDSCH power allocation by UE 200 in accordance with some implementations of the present disclosure.

At step 502, the receiver 214 of UE 200 receives a data signal and a reference signal; wherein a power offset between the data signal and the reference signal is determined by at least one of a first power offset p0 and a second power offset p1.

At step 504, the transmitter 212 of UE 200 transmits a feedback report associated with the reference signal.

FIG. 6 is a flow chart illustrating steps of dynamic PDSCH power allocation by gNB 300 in accordance with some implementations of the present disclosure.

At step 602, the transmitter 312 of gNB 300 transmits a data signal and a reference signal; wherein a power offset between the data signal and the reference signal is determined by at least one of a first power offset p0 and a second power offset p1.

At step 604, the receiver 314 of gNB 300 receives a feedback report associated with the reference signal.

In one aspect, some items as examples of the disclosure concerning UE may be summarized as follows:
1. An apparatus, comprising:
a receiver that receives a data signal and a reference signal; wherein a power offset between the data signal and the reference signal is determined by at least one of a first power offset p0 and a second power offset p1; and
a transmitter that transmits a feedback report associated with the reference signal.
2. The apparatus of item 1, wherein the first power offset p0 is configured by higher layer.
3. The apparatus of item 1, wherein the second power offset p1 is indicated by a control signal or by MAC CE.
4. The apparatus of item 3, wherein the second power offset p1 is selected from an offset power set P1, elements of which are determined by its cardinal number N and a power step S.
5. The apparatus of item 4, wherein the offset power set P1 comprises zero and/or negative integers.
6. The apparatus of item 4, wherein the power step S is configured by higher layer, and N is determined based on the power step S and the first power offset p0; or the cardinal number N is configured by higher layer, and the power step S is determined based on the cardinal number N and the first power offset p0; or both the cardinal number N and the power offset S are configured by higher layer.
7. The apparatus of item 1 or 4, wherein the feedback report comprises a plurality of Channel State Information (CSI) values, that are determined by a plurality of hypothetical power offsets between the data signal and the reference signal.
8. The apparatus of item 7, wherein the hypothetical power offsets comprise at least one of:
the first power offset p0,
the first power offset p0 plus the second power offset p1,
a plurality of power offsets in the offset power set P1,
a plurality of power offsets in a subset of the offset power set P1,
the first power offset p0 plus the second power offset p1, plus or minus a third power offset p2,
a minimal or maximal power offset of any of the above power offsets, and
a constant power offset.
9. The apparatus of item 7, wherein the plurality of CSI values comprises at least one differential CSI value, representing an offset between a first CSI value determined by a first one of the hypothetical power offsets and a second CSI value determined by a reference hypothetical power offset.
10. The apparatus of item 9, wherein the reference hypothetical power offset is one of:
the first power offset p0,
the first power offset p0 plus the second power offset p1,
a smallest power offset of all the hypothetical power offsets,
a smallest power offset of all the hypothetical power offsets that is larger than the first one of the hypothetical power offsets, and
a largest power offsets of all the hypothetical power offsets that is smaller than the first one of the hypothetical power offsets.
11. The apparatus of item 9, wherein the reference hypothetical power offset is a second one of the hypothetical power offsets.

In another aspect, some items as examples of the disclosure concerning gNB may be summarized as follows:
12. An apparatus, comprising:
a transmitter that transmits a data signal and a reference signal; wherein a power offset between the data signal and the reference signal is determined by at least one of a first power offset p0 and a second power offset p1; and
a receiver that receives a feedback report associated with the reference signal.
13. The apparatus of item 12, wherein the first power offset p0 is configured by higher layer.
14. The apparatus of item 12, wherein the second power offset p1 is indicated by a control signal or by MAC CE.
15. The apparatus of item 14, wherein the second power offset p1 is selected from an offset power set P1, elements of which are determined by its cardinal number N and a power step S.
16. The apparatus of item 15, wherein the offset power set P1 comprises zero and/or negative integers.
17. The apparatus of item 15, wherein the power step S is configured by higher layer, and N is determined based on the power step S and the first power offset p0; or the cardinal number N is configured by higher layer, and the power step S is determined based on the cardinal number N and the first power offset p0; or both the cardinal number N and the power offset S are configured by higher layer.
18. The apparatus of item 12 or 15, wherein the feedback report comprises a plurality of Channel State Information (CSI) values, that are determined by a plurality of hypothetical power offsets between the data signal and the reference signal.
19. The apparatus of item 18, wherein the hypothetical power offsets comprise at least one of:
the first power offset p0,
the first power offset p0 plus the second power offset p1,
a plurality of power offsets in the offset power set P1,
a plurality of power offsets in a subset of the offset power set P1,
the first power offset p0 plus the second power offset p1, plus or minus a third power offset p2,
a minimal or maximal power offset of any of the above power offsets, and
a constant power offset.
20. The apparatus of item 18, wherein the plurality of CSI values comprises at least one differential CSI value, representing an offset between a first CSI value determined by a first one of the hypothetical power offsets and a second CSI value determined by a reference hypothetical power offset.
21. The apparatus of item 20, wherein the reference hypothetical power offset is one of:
the first power offset p0,
the first power offset p0 plus the second power offset p1,
a smallest power offset of all the hypothetical power offsets,
a smallest power offset of all the hypothetical power offsets that is larger than the first one of the hypothetical power offsets, and
a largest power offsets of all the hypothetical power offsets that is smaller than the first one of the hypothetical power offsets.
22. The apparatus of item 20, wherein the reference hypothetical power offset is a second one of the hypothetical power offsets.

In a further aspect, some items as examples of the disclosure concerning a method of UE may be summarized as follows:
23. A method, comprising:
receiving, by a receiver, a data signal and a reference signal; wherein a power offset between the data signal and the reference signal is determined by at least one of a first power offset p0 and a second power offset p1; and
transmitting, by a transmitter, a feedback report associated with the reference signal.
24. The method of item 23, wherein the first power offset p0 is configured by higher layer.
25. The method of item 23, wherein the second power offset p1 is indicated by a control signal or by MAC CE.
26. The method of item 25, wherein the second power offset p1 is selected from an offset power set P1, elements of which are determined by its cardinal number N and a power step S.
27. The method of item 26, wherein the offset power set P1 comprises zero and/or negative integers.
28. The method of item 26, wherein the power step S is configured by higher layer, and N is determined based on the power step S and the first power offset p0; or the cardinal number N is configured by higher layer, and the power step S is determined based on the cardinal number N and the first power offset p0; or both the cardinal number N and the power offset S are configured by higher layer.
29. The method of item 23 or 26, wherein the feedback report comprises a plurality of Channel State Information (CSI) values, that are determined by a plurality of hypothetical power offsets between the data signal and the reference signal.
30. The method of item 29, wherein the hypothetical power offsets comprise at least one of:
the first power offset p0,
the first power offset p0 plus the second power offset p1,
a plurality of power offsets in the offset power set P1,
a plurality of power offsets in a subset of the offset power set P1,
the first power offset p0 plus the second power offset p1, plus or minus a third power offset p2,
a minimal or maximal power offset of any of the above power offsets, and
a constant power offset.
31. The method of item 29, wherein the plurality of CSI values comprises at least one differential CSI value, representing an offset between a first CSI value determined by a first one of the hypothetical power offsets and a second CSI value determined by a reference hypothetical power offset.
32. The method of item 31, wherein the reference hypothetical power offset is one of:
the first power offset p0,
the first power offset p0 plus the second power offset p1,
a smallest power offset of all the hypothetical power offsets,
a smallest power offset of all the hypothetical power offsets that is larger than the first one of the hypothetical power offsets, and
a largest power offsets of all the hypothetical power offsets that is smaller than the first one of the hypothetical power offsets.
33. The method of item 31, wherein the reference hypothetical power offset is a second one of the hypothetical power offsets.

In a yet further aspect, some items as examples of the disclosure concerning a method of gNB may be summarized as follows:
34. A method, comprising:
transmitting, by a transmitter, a data signal and a reference signal; wherein a power offset between the data signal and the reference signal is determined by at least one of a first power offset p0 and a second power offset p1; and
receiving, by a receiver, a feedback report associated with the reference signal.
35. The method of item 34, wherein the first power offset p0 is configured by higher layer.
36. The method of item 34, wherein the second power offset p1 is indicated by a control signal or by MAC CE.
37. The method of item 36, wherein the second power offset p1 is selected from an offset power set P1, elements of which are determined by its cardinal number N and a power step S.
38. The method of item 37, wherein the offset power set P1 comprises zero and/or negative integers.
39. The method of item 37, wherein the power step S is configured by higher layer, and N is determined based on the power step S and the first power offset p0; or the cardinal number N is configured by higher layer, and the power step S is determined based on the cardinal number N and the first power offset p0; or both the cardinal number N and the power offset S are configured by higher layer.
40. The method of item 34 or 37, wherein the feedback report comprises a plurality of Channel State Information (CSI) values, that are determined by a plurality of hypothetical power offsets between the data signal and the reference signal.
41. The method of item 40, wherein the hypothetical power offsets comprise at least one of:
the first power offset p0,
the first power offset p0 plus the second power offset p1,
a plurality of power offsets in the offset power set P1,
a plurality of power offsets in a subset of the offset power set P1,
the first power offset p0 plus the second power offset p1, plus or minus a third power offset p2,
a minimal or maximal power offset of any of the above power offsets, and
a constant power offset.
42. The method of item 40, wherein the plurality of CSI values comprises at least one differential CSI value, representing an offset between a first CSI value determined by a first one of the hypothetical power offsets and a second CSI value determined by a reference hypothetical power offset.
43. The method of item 42, wherein the reference hypothetical power offset is one of:
the first power offset p0,
the first power offset p0 plus the second power offset p1,
a smallest power offset of all the hypothetical power offsets,
a smallest power offset of all the hypothetical power offsets that is larger than the first one of the hypothetical power offsets, and
a largest power offsets of all the hypothetical power offsets that is smaller than the first one of the hypothetical power offsets.
44. The method of item 42, wherein the reference hypothetical power offset is a second one of the hypothetical power offsets.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a data signal and a reference signal, wherein a power offset between the data signal and the reference signal is determined by at least one of a first power offset p0 and a second power offset p1; and
transmit a feedback report associated with the reference signal.

2. The UE of claim 1, wherein the first power offset p0 is configured by a higher layer.

3. The UE of claim 1, wherein the second power offset p1 is indicated by a control signal or by a media access control-control element (MAC CE).

4. The UE of claim 3, wherein the second power offset p1 is selected from an offset power set P1, elements of which are determined by a cardinal number N and a power step S of the offset power set P1.

5. The UE of claim 4, wherein the offset power set P1 comprises zero and/or negative integers.

6. The UE of claim 4, wherein:
the power step S is configured by a higher layer, and the cardinal number N is determined based on the power step S and the first power offset p0;
the cardinal number N is configured by the higher layer, and the power step S is determined based on the cardinal number N and the first power offset p0; or
both the cardinal number N and the power offset S are configured by the higher layer.

7. The UE of claim 4, wherein the feedback report comprises a plurality of channel state information (CSI) values that are determined by a plurality of hypothetical power offsets between the data signal and the reference signal.

8. The UE of claim 7, wherein the hypothetical power offsets comprise at least one of:
the first power offset p0,
the first power offset p0 plus the second power offset p1,
a plurality of power offsets in the offset power set P1,
a plurality of power offsets in a subset of the offset power set P1,
the first power offset p0 plus the second power offset p1, plus or minus a third power offset p2,
a minimal or maximal power offset of any of the first power offset p0, the second power offset p1, or the third power offset p2, or
a constant power offset.

9. The UE of claim 7, wherein the plurality of CSI values comprises at least one differential CSI value representing an offset between a first CSI value determined by a first one of the plurality of hypothetical power offsets and a second CSI value determined by a reference hypothetical power offset.

10. The UE of claim 9, wherein the reference hypothetical power offset is one of:
the first power offset p0,
the first power offset p0 plus the second power offset p1,
a smallest power offset of all the hypothetical power offsets,
a smallest power offset of all the hypothetical power offsets that is larger than the first one of the hypothetical power offsets, or
a largest power offsets of all the hypothetical power offsets that is smaller than the first one of the hypothetical power offsets.

11. The UE of claim 9, wherein the reference hypothetical power offset is a second one of the plurality of hypothetical power offsets.

12. A network equipment (NE) for wireless communication, comprising:
at least one memory; and
at least one processor coupled with the at least one memory and configured to cause the NE to:
transmit a data signal and a reference signal, wherein a power offset between the data signal and the reference signal is determined by at least one of a first power offset p0 and a second power offset p1; and
receive a feedback report associated with the reference signal.

13. The NE of claim 12, wherein the second power offset p1 is indicated by a control signal or by a media access control-control element (MAC CE).

14. A method performed by a user equipment (UE), the method comprising:
receiving a data signal and a reference signal, wherein a power offset between the data signal and the reference signal is determined by at least one of a first power offset p0 and a second power offset p1; and
transmitting a feedback report associated with the reference signal.

15. A method performed by a network equipment (NE), comprising:
transmitting a data signal and a reference signal, wherein a power offset between the data signal and the reference signal is determined by at least one of a first power offset p0 and a second power offset p1; and
receiving a feedback report associated with the reference signal.

16. The method of claim 15, wherein the second power offset p1 is indicated by a control signal or by a media access control-control element (MAC CE).

17. The method of claim 14, wherein the first power offset p0 is configured by a higher layer.

18. The method of claim 14, wherein the second power offset p1 is indicated by a control signal or by a media access control-control element (MAC CE).

19. The method of claim 18, wherein the second power offset p1 is selected from an offset power set P1, elements of which are determined by a cardinal number N and a power step S of the offset power set P1.

20. The method of claim 19, wherein the offset power set P1 comprises zero and/or negative integers.
